(19) United States
(12) Patent Application Publication
(10) Pub. No.: US 2013/0332209 A1
(43) Pub. Date: Dec. 12, 2013

(54) Disaster Assistance System and Disaster Assistance Program

(71) Applicant: Katsuya Sawada, Tottori-shi (JP)

(72) Inventor: Katsuya Sawada, Tottori-shi (JP)

(21) Appl. No.: 13/984,605

(22) PCT Filed: Jan. 25, 2012
(86) PCT No.: PCT/JP2012/051508

§ 371 Date: Aug. 26, 2013

(30) Foreign Application Priority Data
Feb. 18, 2011 (JP) 2011-032820

(51) Int. Cl. G06Q 10/06

(52) U.S. Cl. CPC G06Q 10/0631
USPC 705/7.12

(57) ABSTRACT

To provide a disaster support system with which unified management is carried out at least from the management to the transport of disaster relief supplies. A disaster support system (11) comprises: a storage section (112) which stores habitation associated information including populations per area, names and amounts of various disaster relief supplies, and transportation means according to the transported amounts of the disaster relief supplies; an input section (113) wherein instructions are inputted via a user operation; a controller (115) which determines names, amounts, and transportation means of disaster relief supplies to be prepared; and an output section (114) which outputs various information according to the instructions from the controller (115). When a name of a ruined area is inputted via the input section (113), the controller (115) assigns values of each item of the habitation associated information which corresponds to the name of the region into a prescribed formula, determines the names and amounts of each type of the disaster relief supplies to be prepared, and determines the transportation means from the names and amounts of each type of disaster relief supplies to be prepared.

### TECHNICAL FIELD

The present invention relates to a disaster support system for supporting disaster countermeasures and a disaster support program.

### BACKGROUND ART

In recent years, natural disasters such as earthquake and flood disaster are increasing, and thus disaster countermeasures such as lifesaving, evacuation guidance, evacuation spot setup and goods supply at a disaster time are urgent. Various techniques as the disaster countermeasures are proposed.

For example, Patent Document 1 describes an evacuation guiding system for guiding evacuation according to disaster occurrence information and current positions of target persons for evacuation guidance. Concretely, Patent Document 1 discloses an evacuation guiding system characterized by including a receiver for receiving disaster occurrence information about occurrence of various disasters, control means for generating an evacuation control signal based on the disaster occurrence information received by the receiver, a transmitter for transmitting the evacuation control signal, a biological data detecting terminal device owned by the target persons for evacuation guidance for detecting biological data values of the target persons for evacuation guidance through a biological sensor, detecting positions of the target persons for evacuation guidance through position detecting means and notifying the control means of the positions through notifying means, an evacuation guiding section, arranged on a doorway of a room or on a path, for receiving the evacuation control signal so as to display the evacuation guidance or output a sound, and communication means for communicating with a user, wherein the control means generates the evacuation control signal so that the evacuation guiding section executes the evacuation guidance according to the current positions of the target persons for the evacuation guidance detected by the position detecting means, notifies the user of contact information about acquaintance and a current position information list about acquaintance registered in advance as well as request of approval, and transmits the evacuation control signal when the approval is gained from the user or no response is gained from the user.

Further, Patent Document 2 describes an evacuation guiding system for releasing a lock on animals or target persons for evacuation guidance and executing evacuation guidance utilizing data such as emergency earthquake alert and various disaster information. Concretely, Patent Document 2 discloses an evacuation guiding system, characterized by including a receiver for receiving disaster occurrence information from a disaster information center, position detecting means for detecting a position of an animal in a building, communication means for communicating with a user, control means for gaining approval from the user via the communication means and generating an evacuation control signal based on the disaster occurrence information and the approval from the user received by the receiver, a transmitter for generating the evacuation control signal, a lock section that locks a collar or a chain of an animal or a gate of a cage or a barrier and receives the evacuation control signal so as to release the lock, and an evacuation guiding section arranged on a doorway of a room or a passage for receiving the evacuation control signal so as to display the evacuation guidance or output a sound, wherein the control means makes a control according to a current position of the animal detected by the position detecting means so that evacuation guidance of a passage from the doorway near the current position to an outside of a building and the doorway is displayed or output as a sound from the evacuation guiding section.

### PRIOR ART DOCUMENTS

### Patent Documents

Patent Document 1: JP No. 4093319

Patent Document 2: JP No. 3893428

### SUMMARY OF THE INVENTION

### Problem to be Solved by the Invention

One of actual states in the disaster countermeasures that are not described in Patent Documents 1 and 2 is a problem of a great disparity in an amount of stock supplies among areas, countries, or prefectures. In order to solve this problem, it is considered to be effective that management, transportation and set-up of stock supplies are unified beyond the bounds of areas, countries and prefectures. Even when the stock supplies are managed by private enterprises, transportation and set-up of supplies at a disaster time require government organization such as a military unit, and it is absolutely necessary that government and a private sector cooperate. At this time, when the management, transportation and set-up are carried out by individual instructions, an economical prompt response is difficult.

Therefore, in order to solve the above problem, the inventors of the present invention consider an effective unification of the management, transport and set-up, and considers that the structure of a system for enabling at least the unification from the management to the transportation to be supported is effective.

It is an object of the present invention to provide a disaster support system for unifying at least management through transportation of disaster relief supplies. It is another object to provide a disaster support program for operating the disaster support system.

### Means for Solving the Problem

In order to attain the above object, a disaster support system of the present invention is characterized by including a storage section for storing habitation associated information including population in each area, names and amounts of various disaster relief supplies and transport means conforming to transportation amounts of disaster relief supplies, an input section into which an instruction is input by a user's operation, a controller for determining names and amounts of disaster relief supplies to be prepared and transportation means, and an output section for outputting various information according to an instruction from the controller, wherein when a name of a ruined area is input by the input section, the controller assigns each value of each field in the habitation associated information related to each area name to a predetermined formula so as to determine the names and amounts of the various disaster relief supplies to be prepared, and determines the transportation means based on the names and amounts of the various disaster relief supplies to be prepared.

In this constitution, when an area name is input from an input section of a terminal device or an input section of a computer via a telecommunication line, the controller can determine the names and the amounts of the disaster relief supplies and the transportation means necessary in the area accurately and quickly without manual operation.

In the disaster support system, the storage section stores a size and a weight per unit amount according to the names of disaster relief supplies, capacity size and weight in each kind of packing, candidates and a loadable number of packings of the transportation means according to each of the packing forms, priorities of the respective transportation means, and an operable number of the respective transportation means, the controller calculates the packing form and the number of packings based on the name and the amount of each of the various disaster relief supplies to be prepared, the size and the weight per unit amount according to the names of the disaster relief supplies, and the capacity size and weight for each kind of packings, calculates candidates of the transportation means based on the calculated packings form and the candidates of the transportation means according to the various packing forms, and may determine the transportation means in decreasing order of the priorities based on the calculated number of packings, the calculated candidates of the transportation means, the priorities of the respective calculated transportation means, and the number of the operable transportation means.

This constitution enables packing according to the determined form (for example, cardboard, container or the like).

Further, the disaster support system includes a disaster information receiving section for receiving disaster information including a disaster-stricken area and disaster contents, wherein when the disaster information is received, the controller may assign each value of each item in the habitation associated information related to each area name to a predetermined formula so as to determine the names and amounts of the various disaster relief supplies to be prepared, and may determine the transportation means based on the names and amounts of the various disaster relief supplies to be prepared.

In the disaster support system, the storage section may store a personnel work shift table for calculating a number of attendants at each work, packing time according to the names and the amounts of the disaster relief supplies, loading time according to the packing forms and the number of the packings, and approval time required for approval of attendance, and the controller calculates a number of attendants at a preparation work of the day based on the personnel work shift table, divides the packing time by the number of attendants so as to calculate a shortest packing time, divides the loading time by the number of attendants so as to calculate a shortest loading time, and obtains a shortest preparation time that is a sum of the shortest packing time, the shortest loading time and the approval time.

In this constitution, the controller refers to the personnel work shift table so as to be capable of obtaining the shortest preparation time of the disaster relief supplies to be transported to a disaster-stricken area.

Further, in the disaster support system, the storage section stores map information, an average speed of the respective transportation means and a delivery time according to the packing form and the number of the packings, and the controller calculates a transport route to a disaster-stricken area using the map information, divides a distance of the transport route by the average speed of the transportation means to be used so as to calculate a shortest transport time, divides the delivery time by the number of attendants at a transport work in each transportation means so as to calculate a shortest delivery time, and obtains a shortest supply time that is a sum of the shortest transport time and the shortest delivery time.

In this constitution, the controller can obtain the shortest transport time and the shortest supply time. As a result, a shortest preparation completion date can be determined based on a disaster occurrence date and the shortest transport time, and a shortest supply starting date can be determined based on the disaster occurrence date and the shortest supply time.

In disaster-stricken sites where every moment counts, distribution of people (emergency medical technicians, doctors and the like) and delivery of supplies (beds in hospitals, food) has been basically determined by on-site directors due to inaccessibility of information and chaos on the sites. However, an expected date of arrival of disaster relief supplies (for example, rescue party) depends on disaster scale and type, thus, is ambiguous, and this remains an obstacle to decision by the directors. Therefore, with the disaster support system, the controller automatically calculates necessary disaster relief supplies and the date of arrival, so that the directors on the sites can obtain a time period for which the directors should make do with people and supplies on the sites as information. For this reason, this system enable better judgment.

The disaster support system includes a satellite image receiving section for receiving a satellite image of a disaster-stricken area after disaster occurs, the storage section stores a satellite image of each area before disaster occurs, and when satellite images of a plurality of disaster-stricken areas after the disaster occurs are received, the controller collates satellite images before and after disaster with each other so as to calculate a number of disaster-stricken buildings, and may prioritize disaster-stricken areas in decreasing or increasing order of the number of disaster-stricken buildings.

In this constitution, after disaster occurs, the controller collates satellite images of disaster-stricken sites received from a satellite via the telecommunication line with satellite images of the disaster-stricken sites before disaster so as to determine priorities of the disaster-stricken sites to which relief goods are transported. As a result, transportation priorities of the disaster-stricken sites that are judged by people are mechanically judged by the controller, so that disaster relief supplies can be supplied to the disaster-stricken sites without error.

In the disaster support system, the storage section stores evacuation spots of each area and priorities, and the controller may determine the order of the evacuation spots for transportation according to the priorities.

In this constitution, when the controller automatically decides the priorities of the evacuation spots, disaster relief supplies can be supplied to more disaster victims more quickly.

The disaster support system further includes a weather information receiving section for receiving weather information, the storage section stores the map information and hazardous location information representing a place dangerous as the transport route, and when the weather information and the disaster information are received, the controller may take the weather information and the hazardous location information into consideration when calculating a transport route to a disaster-stricken area using the map information.

In this constitution, after the controller specifies various hazardous location information stored in the storage section based on disaster information collected from a disaster information center via the telecommunication line and the weather information from a weather information center, it avoids hazardous location and determines the transportation route to the disaster-stricken sites. As a result, since a hazardous location is avoided and transportation can be carried out according to weather conditions, disaster relief supplies can be supplied to disaster-stricken sites without loss, and a risk of accident occurrence during the transportation can be extremely reduced.

In the disaster support system, the storage section stores evacuation spots in each area, and the controller may calculate transport routes to the evacuation spots in a disaster-stricken area.

In the disaster support system, the storage section stores the three-dimensional images and set-up disposal images of the evacuation spots, and the controller may output the three-dimensional images and the set-up disposal images of the evacuation spots in transportation destination to the output section.

In the disaster support system, the input section is installed in a remote spot of the controller via the telecommunication line, and the input of names of disaster-stricken area through the input section may be regarded as pressing-down of predetermined buttons on the input section.

In this constitution, the controller can display a transportation instruction of the disaster relief supplies stored in the storage section on an output section based on an accident warning signal received by a transmitter-receiver from the input section of the terminal device via the telecommunication line. As a result, the controller can transmit the transportation instruction for disaster relief supplies from chiefs of the disaster-stricken sites (governor and chiefs of municipalities) directly and quickly to a disaster support supplies storage station without bypassing central disaster countermeasure headquarters.

In the disaster support system, the telecommunication line may be a dedicated line.

In this constitution, when the dedicated line is used as the telecommunication line, an ill-disposed actions to be taken by crackers can be prevented in advance.

Further, the disaster support program of the present invention operates any disaster support system in the above description.

### Effect of the Invention

According to the present invention, various disaster relief supplies to be prepared and the transportation means are determined, so that the management through the transportation of disaster relief supplies can be unified. In addition, the shortest preparation time and the shortest supply time are determined, so that the management, the transportation and the delivery of disaster relief supplies can be unified. In addition, the transport route to an evacuation spot and set-up disposal are shown, so that the management, transportation and the set-up of disaster relief supplies can be unified.

### BRIEF DESCRIPTION OF DRAWINGS

FIG. 1 is a block diagram illustrating a constitution of a disaster support system of the present invention.

FIG. 2 is a flowchart illustrating an operation of a computer according to a first embodiment.

FIG. 3 illustrates one example of information list of disaster relief supplies of the present invention.

FIG. 4 illustrates one example of a packing form/transportation means correspondence table of the present invention.

FIG. 5 illustrates one example of a transportation means priority list of the present invention.

FIG. 6 illustrates one example of a warehouse/rack correspondence table of the present invention.

FIG. 7 illustrates one example of a screen displayed on an output section of the present invention.

FIG. 8 is a flowchart illustrating the operation of the computer according to a second embodiment.

FIG. 9 illustrates one example of a personnel work shift table of the present invention.

FIG. 10 illustrates one example of the screen displayed on the output section in the present invention.

FIG. 11 is a flowchart illustrating the operation of the computer according to a third embodiment.

FIG. 12 illustrates one example of evacuation spot information of the present invention.

FIG. 13 illustrates one example of the screen displayed on the output section of the present invention.

FIG. 14 is a flowchart illustrating the operation of the computer according to a fourth embodiment.

FIG. 15 illustrates one example of the screen displayed on the output section of the present invention.

FIG. 16 illustrates one example of the screen displayed on the output section of the present invention.

### MODE FOR CARRYING OUT THE INVENTION

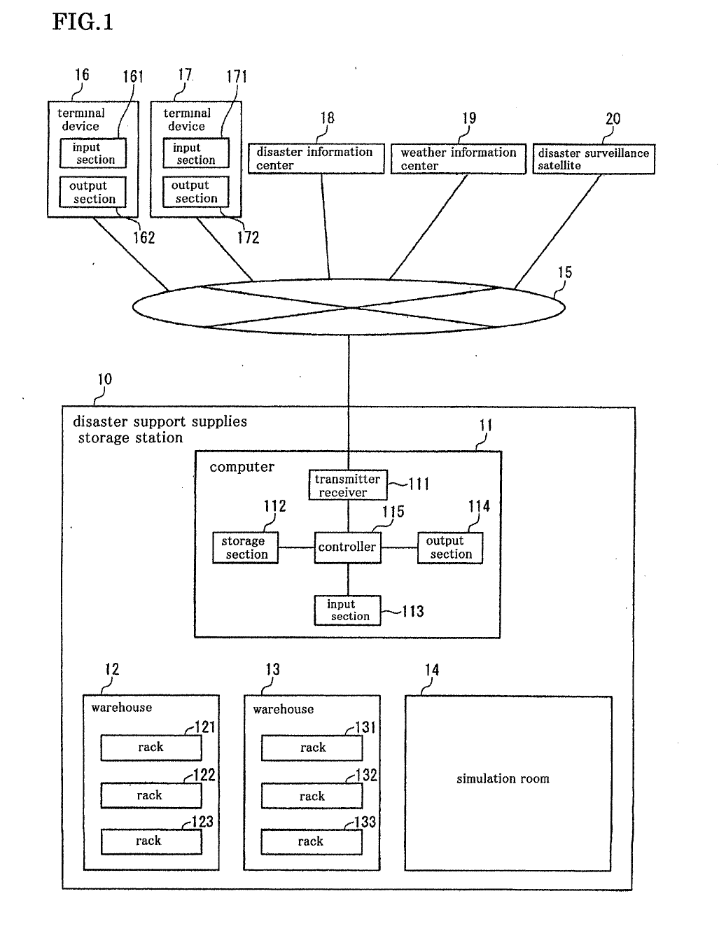

FIG. 1 is a block diagram illustrating a constitution of a disaster support system of the present invention. A disaster support supplies storage station 10 is provided with a computer 11 as the disaster support system, warehouses 12 and 13 for housing various disaster relief supplies, and a simulation room 14 for running a simulation of packing of supplies. The disaster support system 11 is connected to terminal devices 16 and 17 installed in each of local governments, a governmental sector for monitoring disasters, such as a disaster information center 18 of Meteorological Agency, a governmental sector for monitoring weather, such as a weather information center 19 of Meteorological Agency, and a governmental sector for managing and operating a disaster surveillance satellite 20, such as disaster surveillance satellite 20 of Japan Aerospace Exploration Agency (JAXA) via a telecommunication line 15 such as an internet. In the description, the terminal devices 16 and 17 are occasionally included in the disaster support system. Further, in order to improve security, the computer 11 and the terminal devices 16 and 17 may be connected by a dedicated line.

It is desirable from a viewpoint of quick obtaining of transportation means and persons of supplies that the disaster support supplies storage station 10 is desirably adjacent to a government station having transportation capability, such as an air force base.

As disaster relief supplies include water, food (rice, cracker, hardtack, rice gruel and the like), blankets, medicine, fuel, water filter, projector, tent, electricity generator, solar panel, temporary house, and portable toilet. A plenty amount of disaster relief supplies are assumed to be stored in number-assigned racks 121 to 123 and 131 to 133 of the warehouses 12 and 13 according to names and amounts, and stock management is carried out by another computer or another program of the computer 11.

The computer 11 has a transmitter-receiver 111 for transmitting/receiving data via a telecommunication line 15, a storage section 112 composed of a hard disc drive for storing various information, an input section 113 composed of a keyboard into which an instruction is input by a user's operation, an output section 114 composed of a liquid crystal display for outputting various information, and a controller 115 for controlling respective sections. The transmitter-receiver 111, the storage section 112, the input section 113, and the output section 114 may be independent from the controller 115.

The terminal devices 16 and 17 may be a computer such as a personal computer that has the input sections 161 and 171 composed of the keyboard into which an instruction is input by a user's operation, and output sections 162 and 172 composed of a liquid crystal display for outputting various information. Since the terminal devices 16 and 17 are installed in each of local governments and only have to notify the computer 11 of at least disaster occurrence, they may be at least predetermined buttons such as emergency buttons connectable to the telecommunication line 15.

An operation of the computer 11 as the disaster support system is described below in each embodiment.

### First Embodiment

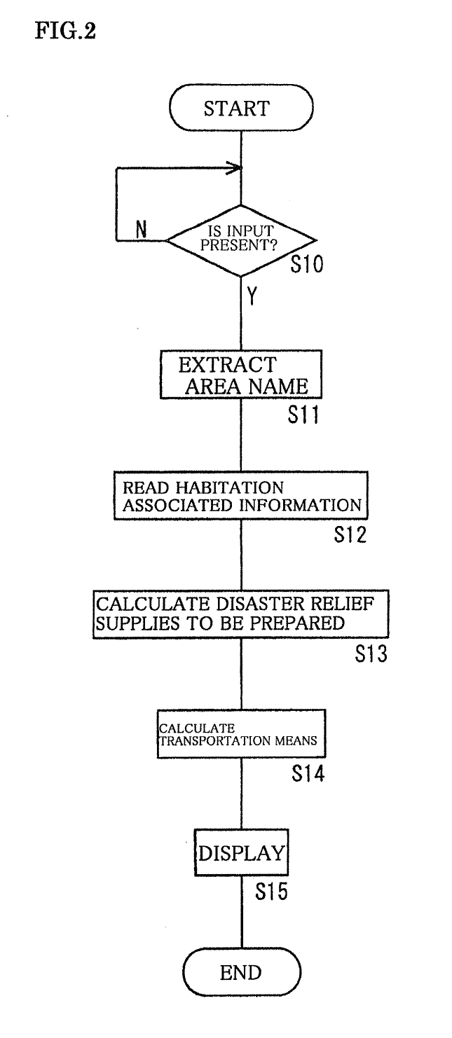

In a first embodiment, a disaster-stricken area is manually input into the computer 11. FIG. 2 is a flowchart illustrating the operation of the computer 11 according to the first embodiment.

When the computer 11 is in a standby state, the controller 115 determines at step S10 whether a name of disaster-stricken area is input through the input section 113 (or input sections 161 and 171). When the name of the area is input according to an instruction from the country and the like, the sequence goes to step 511 and the controller 115 extracts the name of the area.

The sequence then goes to step S12, and the controller 115 reads habitation associated information related to the name of the area from the storage section 112. Habitation associated information is stored in the storage section 112 in advance by using results of national surveillance carried out by national government, such as census, and includes at least population per area, and further population by age, population by sex, a number of households, a number of households including elderly persons (for example, 60 or 65 and older), and states of residences.

The sequence goes from step S12 to step S13, and the controller 115 calculates disaster relief supplies to be prepared for transportation to the disaster-stricken area. Concretely, each value of each item in the habitation associated information is assigned to a predetermined formulas determined in advance for each of disaster relief supplies so as to determine names and amounts of various disaster relief supplies to be prepared.

For example, a necessary amount of rice or hardtack is calculated according to a formula that (population in an area)×0.4. Further, a necessary amount of rice gruel is calculated according to a formula (population of elderly persons in an area)×0.4. A number of blanket is calculated according to a formula (population in an area)−(population aged less than 6 years in an area). The above coefficient 0.4 is calculated by seeing “Survey of Existing Conditions of Fire-Fighting Disaster-Defense Earthquake Disaster Countermeasure” (surveyed by Fire Department) as of Apr. 1, 2001, so as to be obtained based on hardtack stockpiles (4140 meals) per population of 10000 in Tokyo. Another coefficient may be used.

The sequence goes to step S14, and the controller 115 determines transportation means that transports the disaster relief supplies. A user may select whether transportation means is determined. The transportation means is determined based on names and amounts of various disaster relief supplies to be prepared (transported). The transportation means includes, for example, a truck, a reefer truck, a freezer car, a refrigerator car, transport vessel (ship), and a carrier helicopter. At this time, the information list of disaster relief supplies, a packing form/transportation means correspondence table, and a transportation means priority list that are stored in the storage section 112 in advance are also used.

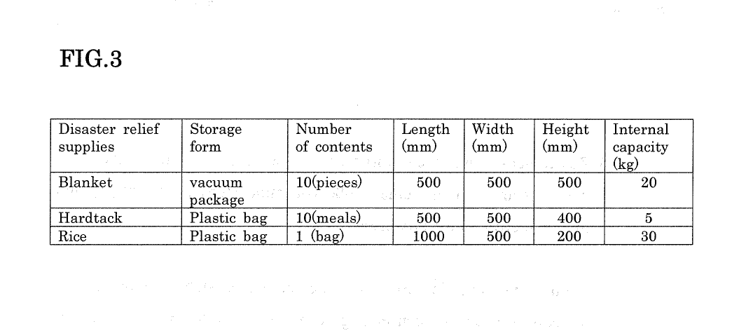

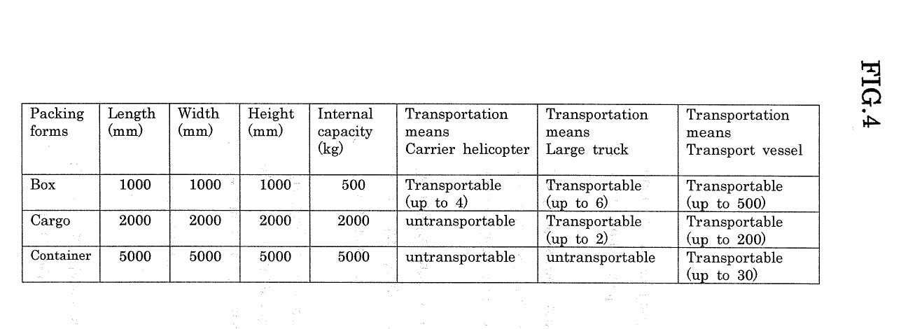

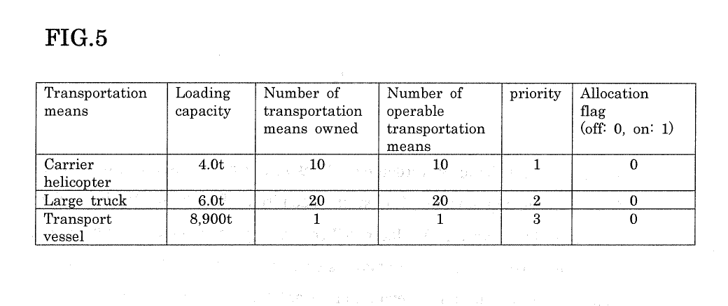

FIG. 3 illustrates one example of the information list of disaster relief supplies, FIG. 4 illustrates one example of the packing form/transportation means correspondence table, and FIG. 5 illustrates one example of the transportation means priority list. A storage form, a number of contents (unit number), a length, a width, a height (size), and an internal capacity (weight) are registered in the information list about relief supplies in FIG. 3 according to the name of each of disaster relief supplies. Packable length, width, height and internal capacity, and a transportation means and a capacity (a loadable number of the packings) that enable transportation of the packing forms are registered in the packing form/transportation means correspondence table in FIG. 4 according to each of the packing forms. A loading capacity, a number of the transportation means owned, a number of operable transportation means, priorities, and allocation flag are registered in the transportation means priority table in FIG. 5 according to each of the transportation means.

The controller 115 searches the information list of relief supplies for the obtained names of disaster relief supplies to be prepared using the names and the amounts of calculated disaster relief supplies to be prepared and the information list of disaster relief supplies in FIG. 3 so as to read corresponding information about the disaster relief supplies. The amount of the disaster relief supplies to be prepared is divided by the number of the contents corresponding to the searched names of the delivery disaster relief supplies so that a necessary number of the disaster relief supplies per unit number is calculated, and a sum of a size (length, width and height) and a weight (internal capacity) is obtained. The packing form and the number of packings are calculated by using the total and the packing form/transportation means correspondence table in FIG. 4. For example, the packing forms are allocated with priority being given to smaller forms, and the calculation is made so that the number of small packings is increased. In FIG. 4, the increasing order of the packing forms is a box, a cargo, and a container.

Further, the controller 115 reads candidates of the transportation means corresponding to the calculated packing form from FIG. 4. The transportation means is determined in decreasing order of priorities based on the calculated number of packings, the calculated candidates of the transportation means, the priorities of respective transportation means in FIG. 5, and the operable number of the respective transportation means in FIG. 5. When the allocated number of the transportation means is subtracted from the operable number and the number of packings exceeds the operable number of transportation means in higher priority, the allocation flag of transportation means (see FIG. 5) is brought into an on state, and a candidate of the transportation means in next priority is also added to the transportation means to be used.

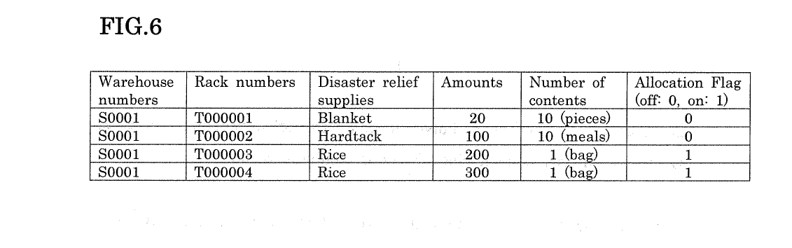

When a warehouse/rack correspondence table is stored in the storage section 112 in advance, a calculation can be made as to which warehouse and which rack the disaster relief supplies to be prepared are stored in the following manner. FIG. 6 illustrates one example of the warehouse/rack correspondence table. Names, amounts, a number of contents (unit number), and the allocation flags of the stored disaster relief supplies are registered in the warehouse/rack correspondence table in FIG. 6 according to the warehouse numbers and the rack numbers.

The controller 115 searches the warehouse/rack correspondence table for the calculated names of the disaster relief supplies to be prepared using the calculated names and amounts of the disaster relief supplies to be prepared and the warehouse/rack correspondence table in FIG. 6, calculates a number of the corresponding disaster relief supplies x a number of contents, and the calculated value is subtracted from the amount of the disaster relief supplies to be prepared so as to bring the allocation flags representing “allocated” into an ON state (in FIG. 6, allocation of 500 bags of rice is completed). This process is repeated until all the disaster relief supplies to be prepared are allocated. Reading of the warehouse numbers and the rack numbers whose allocation flags are ON in the warehouse/rack correspondence table in FIG. 6 can represent which warehouses and which racks the disaster relief supplies to be prepared are stored.

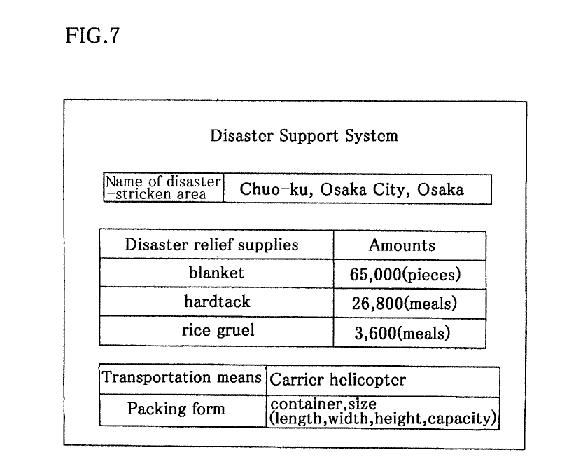

The sequence goes from step S14 to step S15, and the controller 115 displays the calculated and determined results on the output section 114. FIG. 7 illustrates one example of a screen displayed on the output section 114. In this example, an input disaster-stricken area is “Chuo-ku, Osaka City, Osaka Prefecture”. In the storage section 112 , the population in this area is 67000, the population aged less than 6 years is 2000, and the population of the elderly persons is 9000. Therefore, as to the disaster relief supplies, the number of blanket is such that 67000−2000=65000, the number of hardtack is such that 67000×0.4=26800, the number of rice gruel is such that 9000×0.4=3600. The transportation means is carrier helicopter, and the packing form is a container.

According to the disaster support system in the first embodiment, when the name of an area where disaster occurs is input by a user (a person who operates the input section 113), disaster relief supplies to be supplied and their amounts are automatically determined, and a transportation form is also automatically determined. Therefore, the disaster support system can unify management through transportation of the disaster relief supplies.

Further, the disaster support system can be used in training. That is to say, when the user (a person who operates the input section 113) inputs the name of an area where disaster is assumed to occur, the disaster relief supplies to be supplied and their amounts and transportation form can be obtained. For this reason, training such as a packing work and a set-up work can be carried out in the simulation room 14.

### Second Embodiment

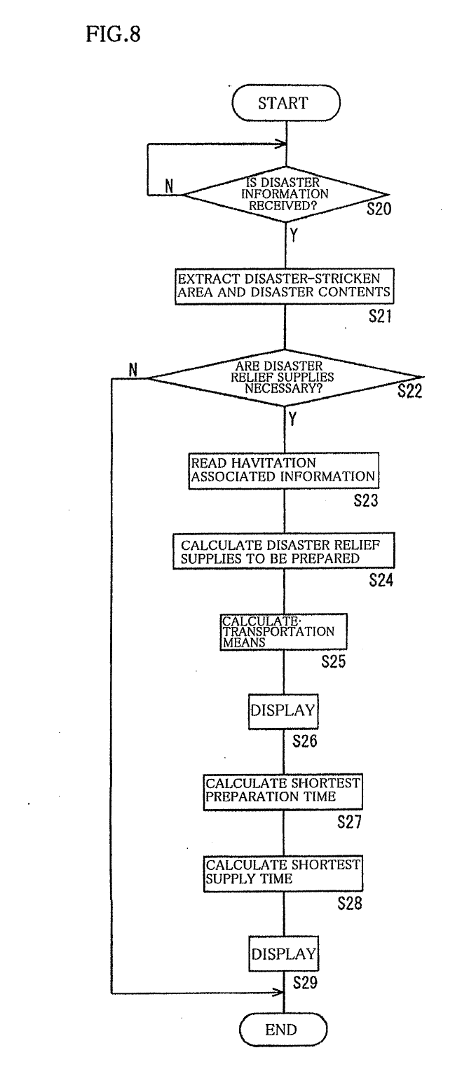

In the second embodiment, the computer 11 automatically receives a disaster-stricken area from the disaster information center 18. FIG. 8 is a flowchart illustrating the operation of the computer 11 according to the second embodiment.

When the computer 11 is in the stand-by state, the controller 115 determines at step S20 whether the transmitter-receiver 111 receives disaster information from the disaster information center 18. The disaster information includes at least a name of disaster-stricken area and disaster contents (for example in a case of earthquake, earthquake intensity and tsunami information), and may further include road conditions, various disaster prevention information released by the government, lifeline information and service status of public transportation. When the disaster information is received, the sequence goes to step S21, and the controller 115 extracts at least the disaster-stricken area and the disaster contents from the disaster information.

The sequence goes to step S22, and the controller 115 reads disaster type/scale information from the storage section 112, and compares the information with the received disaster contents so as to determine whether the supply of the disaster relief supplies is necessary. The disaster type/scale information is stored in the storage section 112 in advance, and includes at least a disaster scale (magnitude) that requires the supply of the disaster relief supplies with respect to each of disaster types. Therefore, when the occurred disaster scale is not less than the stored scale, the controller 115 determines that the supply of the disaster relief supplies is necessary. Example of the disaster type/scale information are earthquake/earthquake intensity 5, tsunami/big tsunami, typhoon/maximum wind speed 50 m, and flood/inundation above floor level.

When the determination is made at step S22 that the supply of the disaster relief supplies is necessary, the sequence goes to step S23, and the controller 115 reads habitation associated information (similar to the first embodiment) corresponding to the name of the disaster-stricken area in the disaster information from the storage section 112.

The sequence goes from step S23 to step S24, and the controller 115 calculates disaster relief supplies to be prepared for transportation to the disaster-stricken area. The sequence goes to step S25, and the controller 115 determines transportation means that transports the disaster relief supplies. The sequence, then, goes to step S26 and the controller 115 displays the calculated and determined results on the output section 114. Since steps S23 to S26 are similar to steps S12 to S15 in the first embodiment, detailed description thereof is omitted.

The sequence goes from step S26 to step S27, and the controller 115 calculates shortest preparation time. The shortest preparation time is a sum of the shortest packing time, shortest loading time and approval time. The shortest packing time is obtained by calculating a number of attendants at a preparation work on the day based on the personnel work shift table for calculating a number of attendants at each work, and dividing the packing time according to the names and the amounts of the disaster relief supplies by the number of attendants at the preparation work on the day. The shortest loading time is obtained by dividing the loading time according to the packing forms and the number of the packings by the number of attendants at the preparation work on the day. The approval time is time required by directors to approve attendance, and a predetermined value (for example, 0.5 hour) is stored in the storage section 112 in advance.

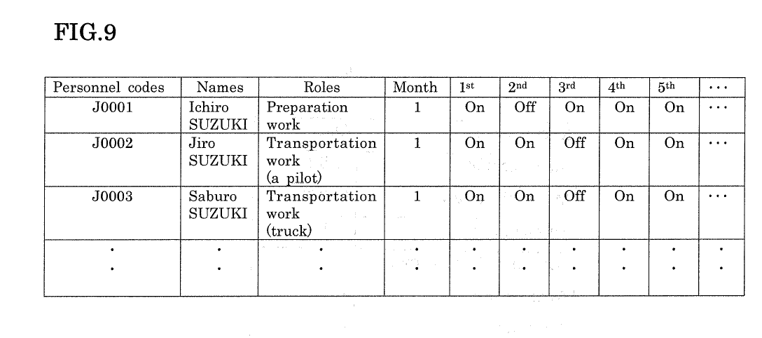

A personnel work shift table is stored in the storage section 112 in advance, and attendance schedules of registered personnels within days are registered. FIG. 9 illustrates one example of the personnel work shift table. Names, roles and attendance/vacation schedules of personnels within days are registered according to personnel codes given to respective personnels. The controller 115 can calculate a number of attendants at each work on the date according to this table. The personnel code is not essential item. The personnel work shift table may further include attendance time and contact information.

The packing time according to the names and the amounts of the disaster relief supplies is stored in the storage section 112 in advance, and is estimated time required for packing determined for each of disaster relief supplies, namely, time required for a case where one person packs a predetermined number (for example, 1) of disaster relief supplies. Therefore, the packing times of respective disaster relief supplies to be prepared are summed up, and this sum is divided by the number of attendants at the preparation work of packing. This obtained value is the shortest packing time.

The loading time according to the packing forms and the number of the packings is stored in the storage section 112 in advance, and is estimated time required when one person loads one packed thing of this form into the transportation means. The loading time estimated for each packing form is stored. Therefore, when the packing forms and number of the packings are determined, the loading time of each packing form is read and the product of it and the number of each packing is calculated, and the integrated values are summed up. When the summed-up value is divided by the number of attendants at the preparation work for the loading, the shortest loading time is obtained.

The sequence goes from step S27 to step S28, and the controller 115 calculates a shortest supply time. The shortest supply time is a sum of the shortest transport time and a shortest delivery time. The shortest transport time is a value obtained by dividing a distance of a transport route by an average speed of transportation means to be used. The shortest delivery time is a value obtained by dividing the delivery time according to the packing forms and the number of the packings by the number of attendants at a transportation work in each transportation means.

The transport route is calculated in a manner that the position of the disaster support supplies storage station 10 and the disaster-stricken area as transportation destination of supplies are overlapped with national map information stored in the storage section 112 in advance, and suitable routes are calculated according to land-sea-and air transportation means. In this case, a route guidance function of a general navigation device may be mounted to the controller 115. When the transport route is determined, the distance of the transport route on the map can be calculated.

As the average speed of the transportation means, an average speed estimated for each transportation means is stored in the storage section 112 in advance. Therefore, when the transportation means and the transport route are determined, the average speed of the transportation means to be used is read, the distance of the transport route is calculated, and the distance of the transport route is divided by the average speed so that the shortest transport time can be calculated.

The delivery time according to the packing forms and the number of the packings is stored in the storage section 112 in advance, and is estimated time required when one person unloads one packed thing of this form from the transportation means. The delivery time estimated for each of the packing forms is stored. Therefore, when the packing forms and the number of the packings are determined, the delivery time of each of the packing forms is read, and a product of it and the number of the packings is calculated, so that the integrated values are summed up. When the summed-up value is divided by the number of attendants at the transportation work in each of the transportation means for the unloading, the shortest supply time is obtained.

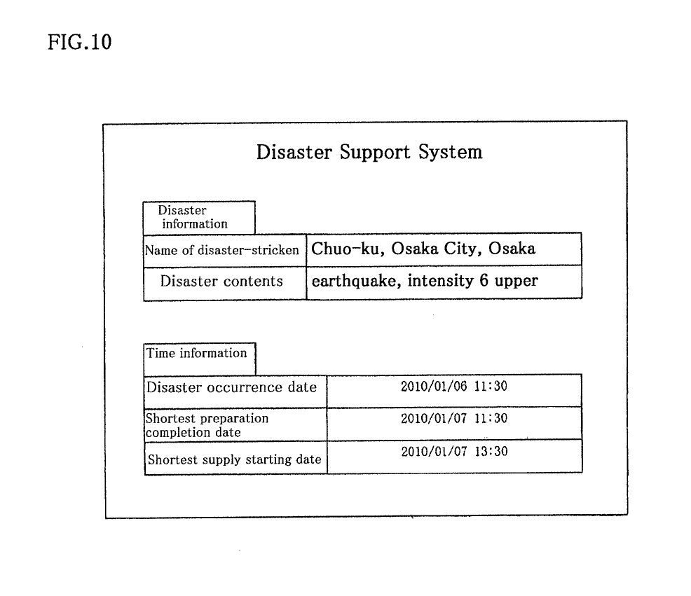

The sequence goes from step S28 to step S29, and the controller 115 displays the calculated and determined results on the output section 114. FIG. 10 illustrates one example of a screen displayed on the output section 114. The screen in FIG. 10 in the wake of the screen in FIG. 7 is displayed on the output section 114. On the screen in FIG. 10, the disaster occurrence date, the shortest preparation completion date (the shortest preparation time) and the shortest supply starting date (the shortest supply time) are shown on the field of the time information. The disaster occurrence date may be extracted from the disaster information. The shortest preparation completion date is obtained by adding the time calculated at step S27 to the date on which the disaster information is received at step S20. Similarly, the shortest supply starting date is obtained by adding the times calculated at steps S27 and S28 to the date on which the disaster information is received at step S20.

In the disaster support system according to the second embodiment, when the disaster information is automatically received, the disaster relief supplies to be supplied and their amounts are automatically determined, and the transportation form is also automatically determined. Further, the shortest preparation time and the shortest supply time are automatically determined. Therefore, the disaster support system can unify the management, the transportation and the delivery of the disaster relief supplies.

Step S26 is omitted, and the contents displayed at step S26 may be also displayed on the screen displayed at step S29. Further, a form in which steps S27 to S29 or step S28 are omitted is considered.

### Third Embodiment

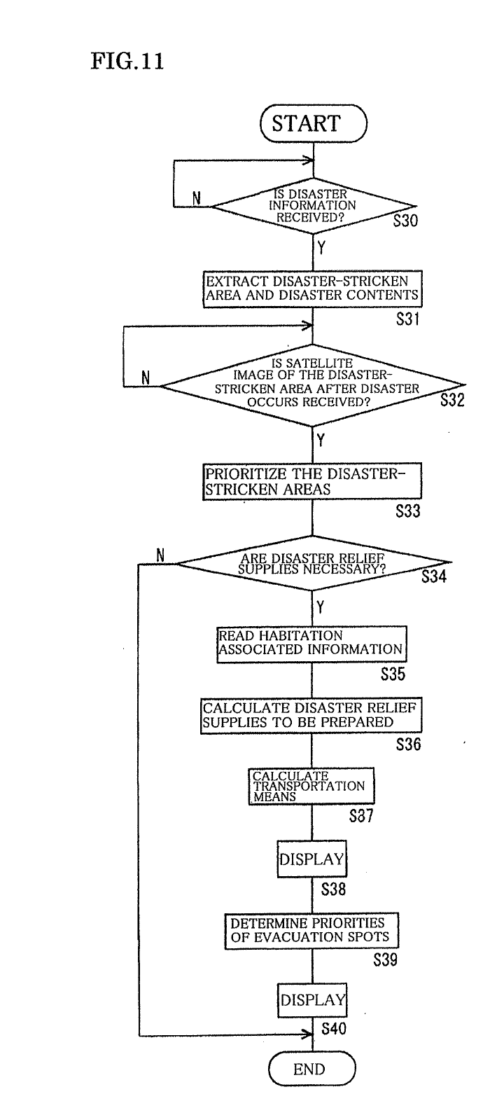

In a third embodiment, satellite images of a disaster-stricken area before and after disaster occurs are utilized. FIG. 11 is a flowchart illustrating the operation of the computer 11 according to the third embodiment.

When the computer 11 is in the standby state, the controller 115 determines at step S30 whether the transmitter-receiver 111 receives disaster information (similar to the second embodiment) from the disaster information center 18. When the disaster information is received, the sequence goes to step S31 and the controller 115 extracts at least the disaster-stricken area and the disaster contents from the disaster information. In a case of wide-scale disaster, disaster information about a plurality of disaster stricken areas is received.

The sequence goes to step S32, and the controller 115 determines whether the transmitter-receiver 111 receives a satellite image of the disaster-stricken area after disaster occurs from the disaster surveillance satellite 20. In the case of a plurality of disaster-stricken areas, the determination is made whether satellite images of the respective disaster-stricken areas are received. As to the satellite images, the computer 11 may request an image of necessary area, or even when the computer 11 does not request it, the disaster surveillance satellite 20 may automatically transmit the image.

When satellite images of all disaster-stricken areas after the disaster, the sequence goes to step S33, and the controller 115 prioritizes the disaster-stricken areas. Concretely, the satellite images before and after the disaster are collated with each other, and the number of disaster-stricken buildings is calculated, so that the disaster-stricken areas are prioritized in decreasing order of the number of the disaster-stricken buildings (first, second, third . . . ). As the satellite images before disaster, national satellite images are stored in the storage section 112 in advance. The number of buildings may be determined by image analysis, and an analysis method is not particularly limited. The disaster-stricken areas may be prioritized in increasing order of the number of disaster-stricken buildings (first, second, third . . . ).

The sequence goes to step S34, and the controller 115 reads the disaster type/scale information (similar to the second embodiment) of the disaster-stricken area with the first-order priority from the storage section 112, and compares it with the received disaster contents so as to determine whether the supply of the disaster relief supplies is necessary.

When the determination is made at step S34 that the supply of the disaster relief supplies is necessary, the sequence goes to step S35, and the controller 115 reads habitation associated information (similar to the first embodiment) corresponding to the name of the disaster-stricken area with the first-order priority from the storage section 112.

The sequence goes from step S35 to step S36, and the controller 115 calculates the disaster relief supplies to be prepared for transportation to the disaster-stricken area. The sequence, then, goes to step S37, and the controller 115 determines transportation means that transports the disaster relief supplies. The sequence, then, goes to step S38 and the controller 115 displays the calculated and determined results on the output section 114. Since steps S35 to S38 are similar to steps S12 to S15 in the first embodiment, detailed description thereof is omitted.

The sequence goes from step S38 to step S39, and the controller 115 determines priorities of evacuation spots in order to determine an evacuation spot in the disaster-stricken area with the first-order priority to which the disaster relief supply is transported. Concretely, priorities of evacuation spots in corresponding disaster-stricken area for transportation are determined according to the described priorities by using the evacuation spot information including the evacuation spots in each area and their priorities. When the evacuation spot with the first-order priority on the satellite image after disaster occurs is destroyed, the evacuation spot with a second-order priority is raised to the first-order priority.

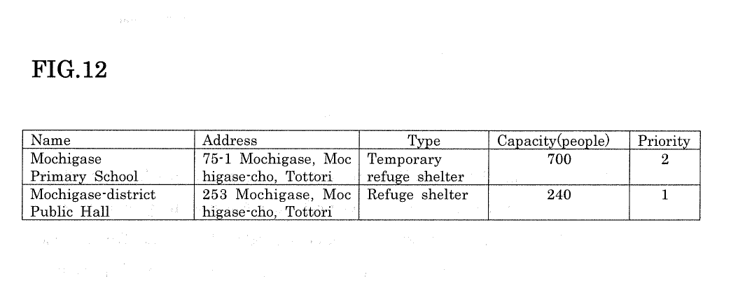

FIG. 12 illustrates one example of the evacuation spot information of the present invention. In a method for determining the priorities of the evacuation spots, priority is given to a type. A refuge shelter has a priority higher than that of a temporary refuge shelter. When types are the same, the evacuation spots are prioritized in decreasing order of capacity. FIG. 12 shows evacuation spot in Mochigase, Mochigase-cho, Tottori City, and the first-order priority is given to Mochigase-district public hall, and the second-order priority is given to Mochigase Primary School as the evacuation spots.

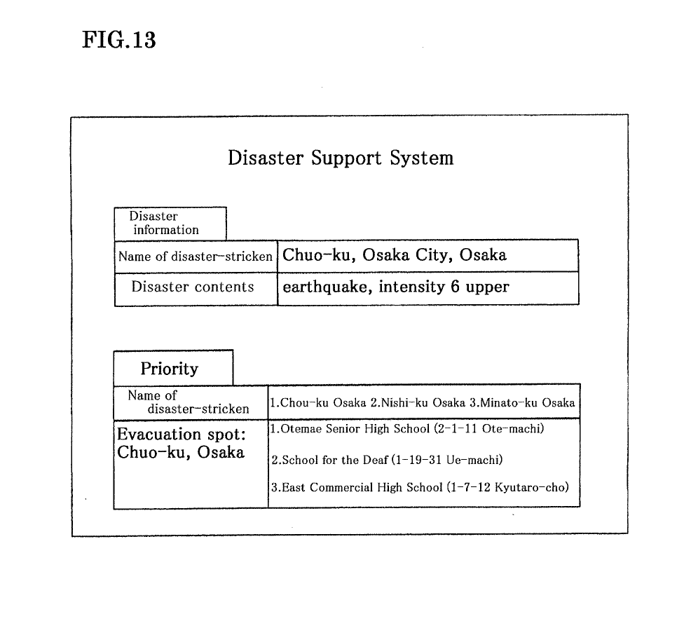

The sequence goes from step S39 to step S40, and the controller 115 displays the calculated and determined results on the output section 114. FIG. 13 illustrates one example of a screen displayed on the output section 114. The screen in FIG. 13 in the wake of the screen in FIG. 7 is displayed on the output section 114. On a screen in FIG. 13, the priorities of disaster-stricken area (first, second, third) are described on the field of the priority of disaster-stricken areas. Further, the priorities of evacuation spots (first, second, third) in Chuo-ku, Osaka City as the disaster-stricken area with the first-order priority are described on the field of the priority of evacuation spot.

In the disaster support system according to the third embodiment, the disaster relief supplies to be supplied and their amounts are automatically determined, the transportation form is also automatically determined, and the priorities of transportation destinations of disaster relief supplies can be determined by utilizing a satellite image of the disaster-stricken area before and after disaster. Therefore, even when wide-scale of disaster occurs, the disaster support system can unify the management through the transportation of the disaster relief supplies.

Step S38 may be omitted, and the contents displayed at step S38 may be also displayed on the screen displayed at step S40. It is desirable that disaster-stricken areas with second-order or lower-order priorities are sequentially subject to the process at S34 and subsequent steps so that the disaster relief supplies are sequentially supplied.

### Fourth Embodiment

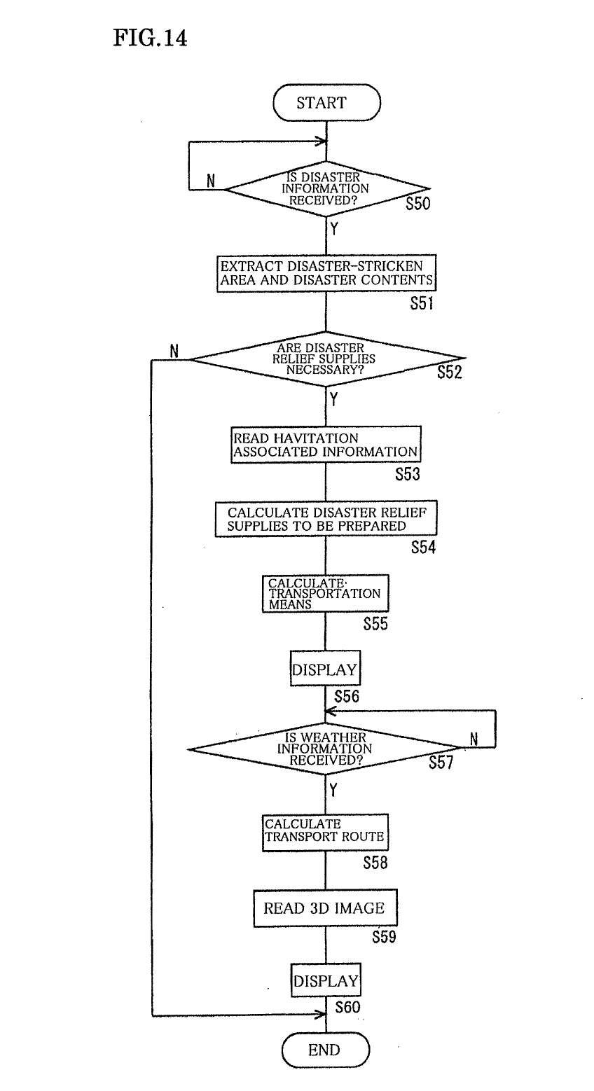

The fourth embodiment illustrates the transport route up to an evacuation spot. FIG. 14 is a flowchart illustrating the operation of the computer 11 according to the fourth embodiment.

Since the process at steps S50 to S56 is similar to the process at steps S20 to S26 in the second embodiment, detailed description is omitted. The sequence goes from step S56 to step S57, and the controller 115 determines whether the transmitter-receiver 111 receives weather information from the weather information center 19. The computer 11 may request weather information about a necessary area, or when the computer 11 does not request it, it may be automatically transmitted from the disaster surveillance satellite 20.

The weather information includes at least various alerts, and may include various warnings, and weather reports. When disaster information is received, the sequence goes to step S58, and the controller 115 calculates the transport route. As to the method for calculating the transport route, in the calculating method at step S28 according to the second embodiment, the weather information and hazardous location information are taken into consideration according to transportation means. The hazardous location information is a place such as a high mountain, a high-voltage electrical power line and a high-rise building on a map to which an attention should be paid at time of transportation, and is stored in the storage section 112 in advance. As the transport route, a route from the disaster support supplies storage station 10 to a disaster-stricken area or an evacuation spot may be calculated.

For example, when a carrier helicopter is used for transportation, the weather information is a route where a gale-warned area is avoided, and when a hazardous location is present on the route, a hazardous location is also displayed so that an attention is called at a time of displaying the route. This method for calculating the transport route may be applied to step S28 in the second embodiment.

The sequence goes from step S58 to step S59, and the controller 115 reads a three-dimensional image and a set-up disposal image of the evacuation spot as the transportation destination from the storage section 112. These images are stored in the storage section 112 in advance. The set-up disposal image shows set-up disposal information about a tent, a rest house, an assembly house, a makeshift health clinic, a soup-up/cooking place, a bath, a toilet place, a heliport, a partition and a communication facility on the evacuation spot on the image.

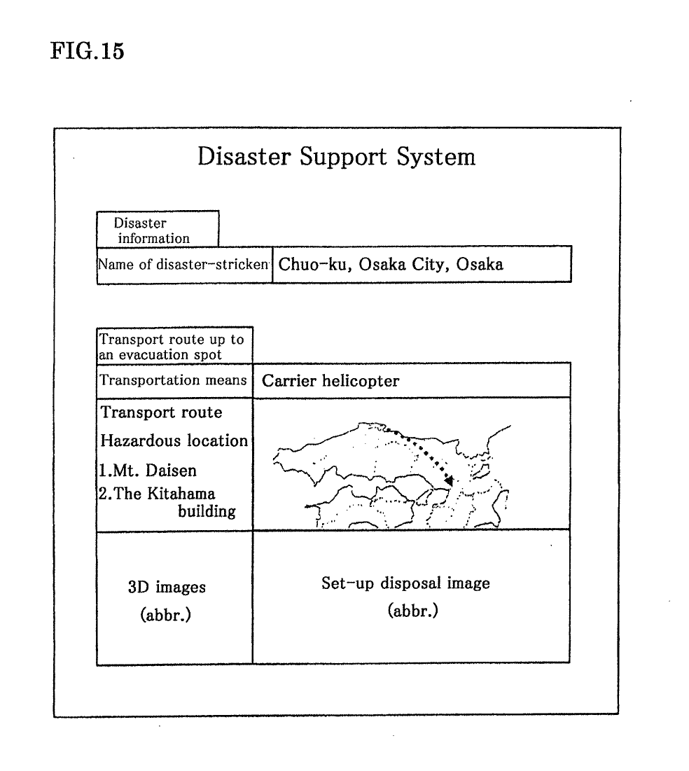

The sequence goes from step S59 to step S60, and the controller 115 displays the calculated, determined and read results on the output section 114. FIG. 15 illustrates one example of a screen displayed on the output section 114. The screen in FIG. 15 in the wake of the screen in FIG. 7 is displayed on the output section 114. A hazardous location and a transport route on the map are displayed on the field of the transport route on the screen in FIG. 15. Further, a three-dimensional image (not shown) of the evacuation spot as the transportation destination, and the set-up disposal image (not shown) are displayed.

When the set-up disposal image is displayed on a mobile terminal such as a tablet PC of a carrier, the carrier can always check it, and thus the set-up on the evacuation spot can be smoothly carried out.

The disaster support system according to the fourth embodiment can automatically determine disaster relief supplies to be supplied and their amounts and also a transportation form, and can show the transport route to the evacuation spot and the set-up disposal. Therefore, the disaster support system can unify the management, transportation and the set-up of disaster relief supplies.

The weather information and the hazardous location information may be added when the transportation means is determined. For example, when a flood warning is issued on disaster-stricken area, land transportation cannot be carried out, and thus a carrier helicopter is determined.

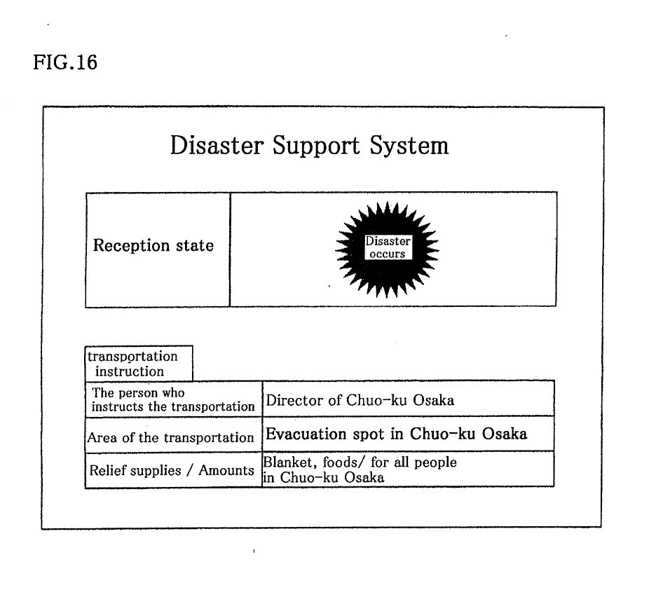

In the above embodiments, when the terminal devices 16 and 17 are emergency buttons provided to each of local governments and the emergency buttons are pressed, local governments (chiefs of local governments) requests the disaster support system for support directly. For this reason, prompt actions can be taken without passing through the national government. FIG. 16 illustrates one example of a screen displayed on the output section 114 of the computer 11 when the emergency button is pressed. The field of the reception state of the screen indicates “disaster occurs”, and it is found that a ward mayer of Chuo-ku, Osaka City requests support.

In the above embodiments, when the transportation means is determined, a condition that a carrier helicopter cannot be used at night may be added. When this condition is added and estimated transportation time is nighttime, a carrier helicopter can be omitted so that the transportation means is determined.

### INDUSTRIAL APPLICABILITY

The present invention can be applied to the disaster support system that supports storage and management of disaster relief supplies on a storage station, and prompt the supply of the disaster relief supplies to disaster-stricken sites when disaster occurs. Further, revelation of the nearest date of arrival is very useful particularly for the local chiefs of disaster-stricken sites when allocation of limited resources on the local sites (people, supplies, and time) is determined.

### EXPLANATIONS OF LETTERS OR NUMERALS

10 disaster support supplies storage station
11 disaster support system
12, 13 warehouse
14 simulation room
15 telecommunication line
16, 17 terminal device
18 disaster information center
19 weather information center
20 disaster surveillance satellite
111 transmitter-receiver
112 storage section
113 input section
114 output section
115 controller
121˜123, 131˜133 rack
161, 171 input section
162, 172 output section

What is claimed is:

1. A disaster support system, comprising:
a storage section for storing habitation associated information including population per area, names and amounts of various disaster relief supplies, a size and a weight per unit number according to the names of disaster relief supplies, capacity size and weight for each kind of packing form, candidates and a loadable number of packings in the transportation means according to each of the packing forms, priorities of the respective transportation means, an operable number of the respective transportation means, a personnel work shift table for calculating a number of attendants at each role, packing time according to the names and the amounts of the disaster relief supplies, loading time according to the packing forms and the number of the packings, and approval time required for approval of attendance;
an input section into which a name of an area is input by a user's operation;
a controller for determining names and amounts of disaster relief supplies to be prepared, and transportation means; and
an output section for outputting various information according to the instruction from the controller, wherein
when a name of a ruined area is input by the input section, the controller assigns a value of each item in the habitation associated information according to each area name into a predetermined formula so as to determine the name and the amount of each of the various disaster relief supplies to be prepared,
calculates the packing form and the number of packings based on the name and the amount of each of the various disaster relief supplies to be prepared, the size and the weight per unit amount according to the names of the disaster relief supplies, and the size and the weight storable in each of the packing forms,
calculates candidates of the transportation means based on the calculated packing forms and candidates of the transportation means according to the packing forms,
determines the transportation means in decreasing order of the priorities based on the calculated number of packings, the calculated candidates of the transportation means, the priorities of the respective transportation means, and the operable number of the respective transportation means,
calculates a number of attendants at a preparation work of the day based on the personnel work shift table, divides the packing time by the number of attendants so as to calculate a shortest packing time, divides the loading time by the number of attendants so as to calculate a shortest loading time, and obtains a shortest preparation time that is a sum of the shortest packing time, the shortest loading time and the approval time.

2. The disaster support system according to claim 1, wherein
the storage section stores map information, an average speed of the respective transportation means and a delivery time according to the packing forms and the number of the packings,
the controller calculates a transport route to a disaster-stricken area using the map information, divides a distance of the transport route by the average speed of the transportation means to be used so as to calculate a shortest transport time, divides the delivery time by the number of attendants at a transport work in each transportation means so as to calculate a shortest delivery time, and obtains a shortest supply time that is a sum of the shortest transport time and the shortest delivery time.

3. The disaster support system according to claim 1, further comprising:
disaster information receiving section for receiving disaster information including disaster-stricken area and disaster contents, wherein
when the disaster information is received, the controller assigns each value of each field in the habitation associated information related to each area name to a predetermined formula so as to determine the names and amounts of the various disaster relief supplies to be prepared, and determines the transportation means based on the names and amounts of the various disaster relief supplies to be prepared.

4. A disaster support program for operating the disaster support system according to claim 1.

5. The disaster support system according to claim 2, further comprising:
disaster information receiving section for receiving disaster information including disaster-stricken area and disaster contents, wherein
when the disaster information is received, the controller assigns each value of each field in the habitation associated information related to each area name to a predetermined formula so as to determine the names and amounts of the various disaster relief supplies to be prepared, and determines the transportation means based on the names and amounts of the various disaster relief supplies to be prepared.

6. A disaster support program for operating the disaster support system according to claim 2.

7. A disaster support program for operating the disaster support system according to claim 3.

8. A disaster support program for operating the disaster support system according to claim 5.
